(19) United States
(12) Patent Application Publication
(10) Pub. No.: US 2026/0001051 A1
(43) Pub. Date: Jan. 1, 2026

(54) SELF-CLEANING REMOTE GRAVIMETRIC BATCH BLENDER WITH DUST-TIGHT DISTRIBUTOR

(71) Applicant: Ampacet Corporation, Tarrytown, NY (US)

(72) Inventor: Eli MARGALIT, Moshav Ya'ad (IL)

(21) Appl. No.: 19/245,939

(22) Filed: Jun. 23, 2025

Related U.S. Application Data
(60) Provisional application No. 63/664,377, filed on Jun. 26, 2024.

(51) Int. Cl. B01F 33/81; B01F 35/10; B01F 35/71

(52) U.S. Cl. CPC B01F 33/813; B01F 35/1453; B01F 35/7141; B01F 35/71731

(57) ABSTRACT

A system for processing material feeds for use by a plurality of processing machines includes an upstream batch blender, a downstream manifold, and a system controller. The batch blender prepares blended batches of material feeds from multiple batch components according to material feed formulations stored at the system controller. The manifold distributes materials feeds made by the batch blender to a plurality of buffer chambers for temporary storage and subsequent delivery to the plurality of processing machines. The system is configured to form dust-tight seals between separate system components that handle the material feeds, and to execute a self-cleansing process to remove residual material feed elements between separate processing runs of differently formulated material feeds, thereby avoiding cross-contamination of the separately formulated material feeds.

### FIELD OF THE INVENTION

The present invention relates to apparatuses and methods for processing material feeds in industrial processes. In particular, the present invention is directed to apparatuses and methods for preparing and distributing several different materials feeds to multiple processing machines.

### BACKGROUND OF THE INVENTION

Plastics are currently the material of choice for the manufacture of a seemingly unlimited number of products. These products are produced by a variety of industrial processes, including, for example, injection molding, blow molding, extrusion, 3D printing, etc. These processes use machines that produce manufactured parts from material feeds that are generally a mixture of polymers (commonly referred to as resin, raw material, or virgin in the industry) in the form of small beads, colorants, and other additives (e.g., ultraviolet light inhibitors). Colorants and other additives in the mixed material feed are normally supplied as masterbatches. A masterbatch is a concentrated mixture of pigments and/or additives that is produced in advance of the production process by heating the pigments and/or additives to encapsulate the same in a carrier resin, and then cooling and cutting the carrier resin into a volume of granules.

It is customary in the plastic industry to supply processing machines either with premixed plastic formulations or with a material feed flow directly from an upstream gravimetric blender that weighs and blends the various components based on predetermined weight settings. In large facilities, it is common to deliver material feed flows to processing machines by preparing premixed formulations of a material feed in an upstream Remote Gravimetric Batch Blender (RGBB) by mixing resins, colored masterbatch and additives though a number of gravimetric blenders to achieve desired 25 qualities and color in the material feed, and then transporting the mixed material feed to the individual processing machines.

A large manufacturing facility may comprise many processing machines of different types, each of which receive material feeds of different formulations for simultaneously producing several different products. In such facilities, one or more RGBB s may generate material feeds with specific formulations required for each machine, and then feed the material feeds to the corresponding processing machines. It is preferable that the RGBB operate automatically, adding each component of a material feed with a predetermined weight into a common weighing hopper. Once the proper amount of each component has been dispensed into the weighing hopper, the combined components are then dropped into a mixing chamber for mixing the same into a homogenously blended batch.

After mixing in the mixing chamber, a blended batch is passed through an automatic manifold that conveys each specific blended batch to a processing machine that requires a material feed of the specific blended batch for producing a predetermined article. The automatic manifold is provided, generally, as an assembly of an input component adapted to receive blended batches from the mixing chamber at a first end and an output component adapted to selectively output blended batches to one of a plurality of delivery pipes for conveying the blended batches to corresponding processing machines in need of the specific blended batches.

FIG. 1 provides a schematic of a conventional RGBB 10 comprised of a system controller (not shown) and four or more RGBBs 12. Each RGBB 12 comprises four bins 14 each of which is fed with a required raw material from one of six or more silos 16. Material from each bin 14 drops into a weighing hopper 17 connected to a load cell 18. The material from each bin 14 is weighed separately in the weighing hopper 17 in serial fashion, and only when the required amounts of all materials have been provided is the batch then allowed to drop into a mixing chamber 20, which mixes the several materials into a homogenously blended batch. After thorough mixing, a blended batch drops from the mixing chamber 20 and passes to an automatic manifold 22 that routes the blended batch to a corresponding processing machine 24.

Optionally, manifold 22 may deliver blended batches to one or more buffer containers (not shown) positioned in-line with the processing machines 24, with the blended batches remaining in the buffer containers until needed at the corresponding processing machines 24. When a processing machine 24 requires further material feed, a blended batch in a corresponding buffer container is then fed to the respective processing machine 24 via a feed line (not shown). The automatic manifolds are in principle constructed with two similar base units connected via a pipe. One of the base units is connected to inlet pipes that arrive from the RGBB's 12 and the other is connected to the outlet pipes that lead to the processing machines 24.

FIG. 2 shows a close-up of one type of manifold 22, which may be used as the automatic manifold in FIG. 1. The manifold 22 includes a first input component 121, such as a funnel, that is adapted to receive premixed blends, and a second output component 122 that is in a material feed flow communication with the input component 121. The output component 122 is adapted to convey blended batches received at the input component 121 to one of a plurality of delivery pipes 124 that each lead to a specific processing machine 24 (or an intermediary buffer container). The output component 122 includes a distributor pipe 123 that is movable, via a motor 125, for selectively communicating with each of the delivery pipes 124. When the system controller determines that a specific blended batch is needed for delivery to a specific processing machine 24, the controller outputs a signal triggering the motor 125 to move the distributor pipe 123 to a predetermined delivery pipe 124 corresponding with the specific processing machine 24 in need of the blended batch, and then outputs a signal for delivering the specific blended batch into the input component 121 of the manifold 22. After flowing into the input component 121, the blended batch flows into the distributor pipe 123 of the output component 122 and then into the specific delivery pipe 124 for conveyance to the specific processing machine 24.

Conventionally, delivery of a blended batch into and through the manifold 22 is effected under the force of gravity, with flow of the blended batch through the delivery pipe 124 effected under a vacuum force generated by a vacuum feeder positioned along the delivery pipe 124. In some cases, the input component 121 may instead be provided with a similar construction as the output component 122, though in an inverted configuration, with a distributor pipe provided in the input component 121 that is adapted to rotate between several positions for aligning with the outlets of multiple different individual mixing chambers 20 for directing a blended batch from the outlet of an aligned mixing chamber 20, into the distribution pipe 123 of the output component 122, and into an aligned delivery pipe 124.

While systems such as the foregoing have increased efficiencies in the manufacture of plastic articles, there remains opportunities for yet further advancing the state of the art, and improving the automated delivery and conveyance of blended batches from an RGBB to a plurality of processing machines.

### SUMMARY OF THE INVENTION

The present invention is inclusive of systems for processing material feeds for use by a plurality of processing machines. Such systems are provided with an upstream batch blender, a downstream manifold, and a system controller.

The batch blender is a remote gravimetric batch blender comprising a plurality of supply hoppers each holding a separate batch component, a single weighing hopper downstream of the plurality of supply hoppers for receiving the separate batch components from each supply hopper to yield a weighed composite batch, and a mixing chamber downstream of the weighing hopper for receiving a weighed composite batch from the weighing hopper to yield a blended batch.

The manifold comprises a distributor and a plurality of buffer chambers. The distributor comprises a distributor arm that is selectively engageable with reception portals at each of the plurality of buffer chambers for delivering blended batches of material feed from the mixing chamber of the batch blender to the plurality of buffer chambers. The distributor arm and reception portals are adapted to engage one another in a dust-tight seal. The distributor further comprises a distributor plate that is adapted to close-off the reception portals of any buffer chamber that is not targeted for engagement by the distributor arm. The distributor plate and reception portals are adapted to engage one another in a dust-tight seal.

The system controller is configured to control movements of the distributor arm via a motor that enables both horizontal and vertical displacements of the distributor arm for engaging and disengaging reception portals of the plurality of buffer chambers. The buffer chambers are arranged in a circular arrangement, and the distributor arm is configured for horizontal displacements via a rotational movement around a vertical axis at a center of the circular arrangement.

The system controller is configured for controlling the batch blender and the manifold for preparing and distributing multiple material feeds for use by the plurality of processing machines. The system controller comprises a memory storing instructions for controlling the system to prepare the multiple material feeds, with each material feed having a different formulation of batch components from one another. The instructions stored in the memory of the system controller enable the system to prepare the multiple material feeds using the same single weighing hopper for each of the differently formulated material feeds. The system controller monitors a fill level of the plurality of buffer chambers, and to control the batch blender and distributor for providing further material feed to any buffer chamber that is determined to contain a material feed volume below a predetermined threshold.

The system further comprises a pressurized fluid source containing a pressurized fluid and one or more fluid nozzles provided to one or more system components, the one or more fluid nozzles being in a fluid flow communication with the pressurized fluid source for delivering the pressurized fluid to the one or more system components for cleansing the system of residual material feed elements between separate processing runs for the preparation of material feeds. At least one fluid flow nozzle is provided at the weighing hopper, the mixing chamber, and/or the distributor; though it is preferable that at least one fluid flow nozzle is provided at each thereof.

The system controller is configured such that, when controlling the system to switch from a first processing run for preparing a first material feed having a first formulation to a second processing run for preparing a second material feed having a second formulation, the system controller commands the system to execute a cleansing process by delivering the pressurized fluid to the one or more fluid nozzles between the first and second processing runs.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a conventional system with a remote gravimetric batch blender (RGBB), a manifold, and a plurality of processing machines;

FIG. 2 shows an example of a manifold according to the system in FIG. 1;

FIG. 3 shows an RGBB according to the present invention;

FIG. 4 shows a manifold according to the present invention;

FIG. 5 shows a side-elevation view of the manifold of FIG. 4, with omission of the distributor housing;

FIG. 6 shows a top plan view of the manifold in FIG. 5, as viewed along plane VI-VI; and

FIG. 7 shows a close-up view of the manifold in FIG. 6, as seen at region VII.

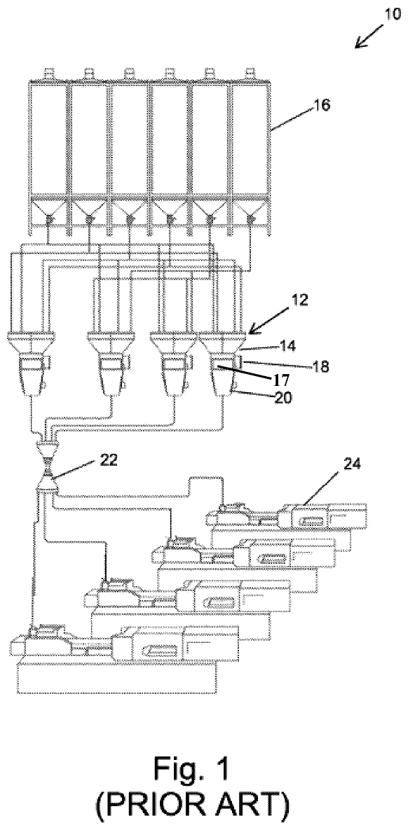

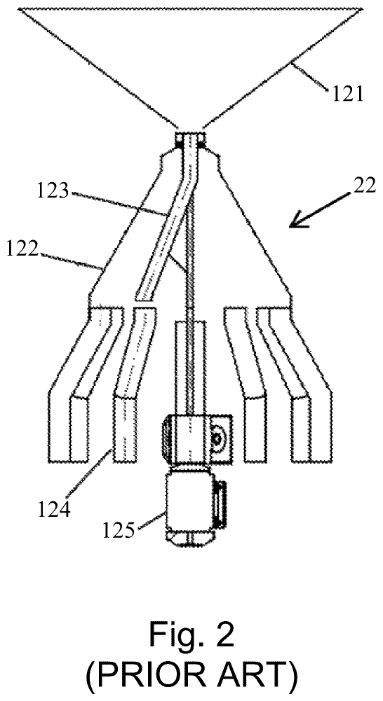

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small so as to not appreciably detract from the identified property or circumstance. The exact degree of deviation allowable in a given circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approx. +/−10%; in other instances, there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present invention is inclusive of a system comprising a single-weighing remote gravimetric batch blender (RGBB) and a zero-cross-contamination distributor (dust-tight manifold).

The RGBB is operable to combine multiple various batch components to produce several blended batches of varying formulations, and the manifold is operable to deliver the blended batches as material feeds to one or more downstream processing machines. When combining the various batch components to produce a blended batch, the RGBB provides each batch component at a predetermined weight to ensure accuracy of the resulting blended batch in meeting a predetermined formulation (recipe) required by the respective processing machines.

Systems according to the present invention are adapted to clean one or more components of the system to remove any residual elements that may remain within the system following processing of a blended batch. This helps to further ensure that blended batches processed by the system are provided with accurate formulations, and without contamination. In operation, it is preferable that one or more system components be cleaned between individual processing runs in which blended batches of different formulations are prepared.

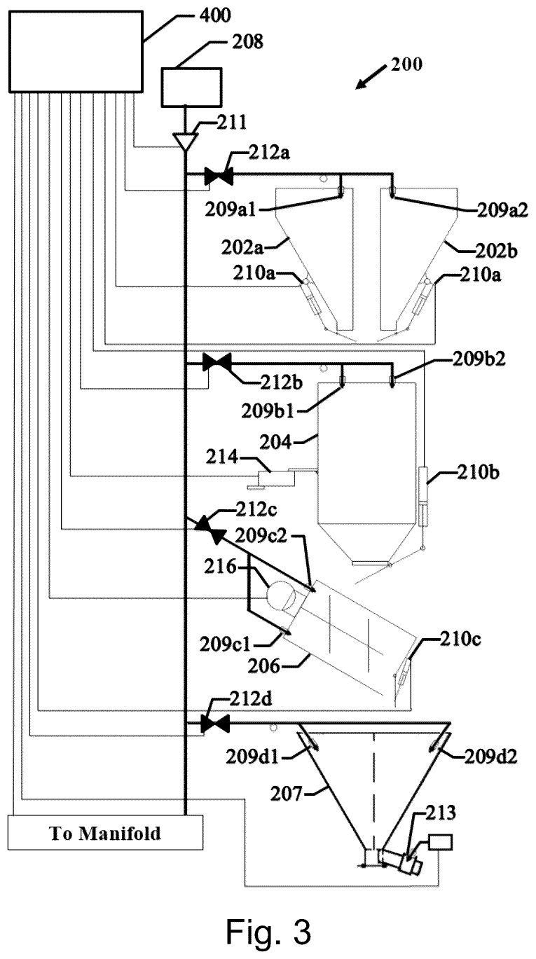

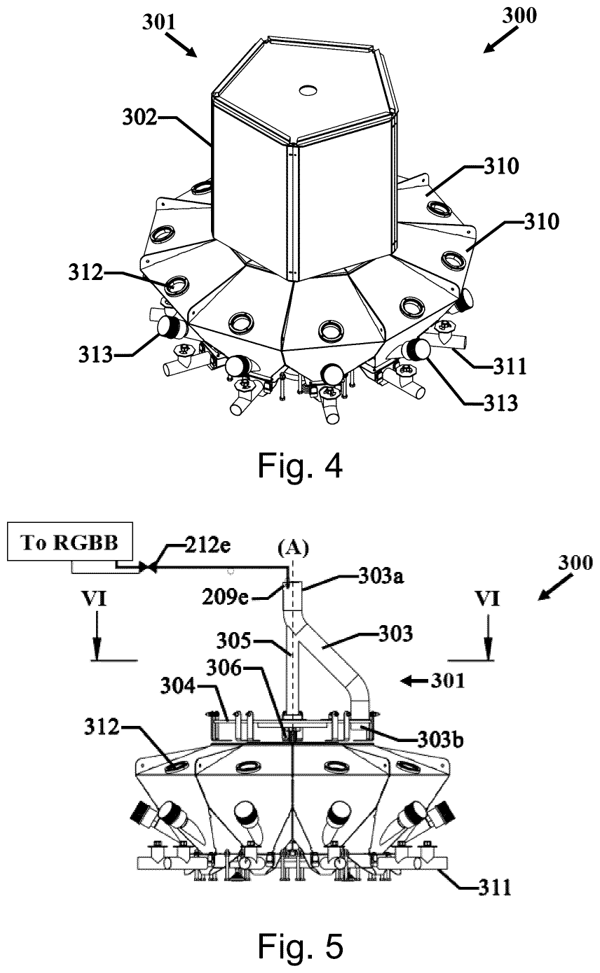

FIG. 3 shows an example of a single-weighing remote gravimetric batch blender (RGBB) 200 according to the present invention; and FIGS. 4-6 show one example of a manifold 300 according to the present invention. The RGBB 200 is configured to prepare blended batches with predetermined formulations according to recipes contained in a system controller 400; and the manifold 300 is configured for distributing individual blended batches among several processing machines (not shown) in accord with instructions contained within the system controller 400.

The system controller 400 comprises a processor, a memory and instructions stored in the memory and executable by the processor for controlling the RGBB 200 and the manifold 300, and optionally other components of the overall system, to produce and distribute blended batches for use by one or more processing machines. The system controller 400 is in signal communication with several gate units 210 and flow valves 211/212 of the RGBB 200, as well as a load cell 214 of a weighing hopper 204 and a motor 216 of a mixing chamber 206. The system controller 400 is in further signal communication with several components of the manifold 300, such as a motor 306 of a distributor arm 303 and positional sensors at a distributor plate 304 and/or several buffer chambers 310. Optionally, the system controller 400 may also be in signal communication with a material feed processing system (not shown) upstream of the RGBB 200 and/or a plurality of processing machines (not shown) downstream of the manifold 300.

The RGBB 200 shown in FIG. 3 is provided with a single weighing hopper 204 that receives batch components from multiple supply hoppers 202. The weighing hopper 204 weighs the batch components to yield a composite batch with a predetermined formulation corresponding with that stored in a memory of the system controller 400. The weighing hopper 204 feeds a weighed composite batch to a downstream mixing chamber 206, which then outputs a mixed composite batch to a downstream funnel 207. Unlike conventional systems in which a separate RGBB unit is provided for processing each individual blended batch formulation, systems according to the present invention are adapted for processing multiple blended batches of varying formulations using a single RGBB 200 with a single weighing hopper 204.

In the RGBB 200, there is provided a collection of supply hoppers 202, which may be provided in any number of individual hoppers, each containing a separate batch component. Each supply hopper 202 retains a given batch component for use in generating pre-formulated blended batch according to recipes stored in the system controller 400. Each supply hopper 202 may receive a batch component from an upstream masterbatch source (not shown), or the supply hoppers 202 may themselves be a masterbatch source for the respective batch components. A single weighing hopper 204 is provided for receiving batch components from the collection of supply hoppers 202, and a load cell 214 is provided at the weighing hopper 204 for weighing a composite batch comprised of several batch components received within the weighing hopper 204 from the supply hoppers 202. A mixing chamber 206 is provided for receiving a composite batch from the weighing hopper 204 once it has been confirmed that all batch components have been received in the weighing hopper 204 at the predetermined weights for yielding a predetermined batch formulation. A funnel 207 provided downstream of the mixing chamber 206 is configured for receiving a homogenously blended batch output from the mixing chamber 206 and delivering the same to a downstream manifold 300.

In operation, the system controller 400 selects a predetermined formulation for a given blended batch that is needed for delivery as a material feed to one or more processing machines. The system controller 400 then operates gate units 210a on the supply hoppers 202 to effect delivery of the necessary batch components for preparation of the predetermined blended batch formulation into the weighing hopper 204. Preferably, the system controller 400 operates a single gate unit 210a at any given moment, thereby delivering the batch components from individual supply hoppers 202 sequentially. The load cell 214 monitors a load at the weighing hopper 204 and outputs a signal to the system controller 400 informing of a current load and changes to the load. The system controller 400 uses outputs from the load cell 214 to operate the gate units 210a at the supply hoppers 202 to ensure a proper weight of each batch component is delivered to the weighing hopper 204. Upon determining that all necessary batch components for preparation of the predetermined blended batch formulation have been delivered to the weighing hopper 204, the system controller 400 operates a gate unit 210b of the weighing hopper 204 to release the composite batch with the predetermined formulation from the weighing hopper 204 for reception in the mixing chamber 206. The system controller 400 then commands a motor 216 at the mixing chamber 206 to thoroughly mix the composite batch to yield a blended batch having the predetermined formulation. The system controller 400 then operates a release valve 210c at the mixing chamber 206 to release the blended batch to the funnel 207 which delivers the blended batch to the manifold 300. Optionally, the funnel 207 may also include a gate unit or release valve under control of the system control 400 for controlling a timing for release of the blended batch from the funnel 207 to the manifold 300.

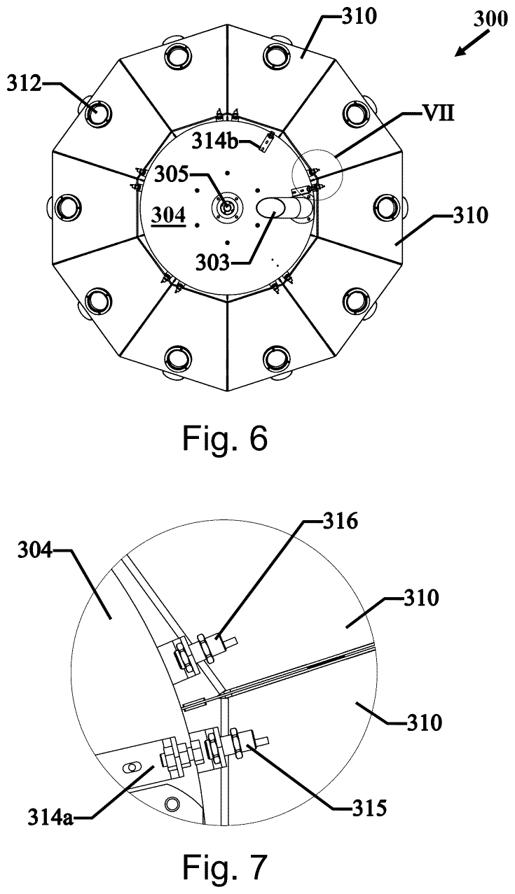

As seen in FIGS. 4-6, the manifold 300 is provided with a distributor 301 and a plurality of buffer chambers 310. The distributor 301 comprises a distributor housing 302 enclosing a distributor arm 303 and a distributor plate 304. FIG. 5 shows the manifold 300 with omission of the distributor housing 302 to provide an unobstructed view of the distributor arm 303 and the distributor plate 304, and FIG. 6 shows a top plan view of the manifold 300 as seen along plane VI-VI in FIG. 5.

In the illustrated example, the distributor arm 303 is provided as a pipe having a first input end 303a configured for reception of a material feed flow from an outlet of the funnel 207 and a second output end 303b configured for delivering a material feed flow to one of several buffer chambers 310. In other examples, the distributor arm 303 may be replaced with another conveyor arrangement having a first input component and a second output component, and in some examples one or more elements may be added or omitted upstream of the distributor 301 for facilitating conveyance of blended batches from the mixing chamber 206 to the distributor arm 303 (or other conveyor arrangement), such as omission of the funnel 207 or the inclusion of one or more additional feed flow elements.

The distributor arm 303 is mounted on a support beam 305 and configured for a horizontal rotation in a 360° range around a rotation axis (A) extending along the support beam 305, such that the distributor arm 303 may be rotated to align with reception portals (not shown) on each of the buffer chambers 310. A distributor plate 304 is mounted on the support beam 305, with the output end 303b of the distributor arm 303 passing through the distributor plate 304 at a predetermined position. The distributor arm 303 and distributor plate 304 are rotatable about the rotation axis (A) via rotation of the support beam 305 under the power of a motor 306 positioned below the distributor plate 304 and 25 controlled by the system controller 400.

In addition to a horizontal rotational movement, the distributor arm 303 is also adapted for vertical movement. Vertical movement of the distributor arm 303 is likewise achieved via the support beam 305 and the motor 306, with the system controller 400 commanding the motor 306 to effect a first vertical translation of the support beam 305 to raise the distributor arm 303 and a second vertical translation of the support beam 305 to lower the distributor arm 303. Vertical movement of the distributor arm 303 enables the output end 303b thereof to be vertically inserted through a reception portal (not shown) of a buffer chamber 310 thereby removing any gap between the two and avoiding spillage of a material feed flow. Optionally, the distributor plate 304 may likewise be configured for vertical movement together with the distributor arm 303, or the distributor plate 304 may be configured to remain at a fixed vertical height with the distributor arm 303 being vertically displaceable relative to the distributor plate 304.

When configured to remain at a fixed vertical height, the distributor plate 304 may be mounted to the support beam 305 via a selective interference arrangement such that rotation of the support beam 305 confers a corresponding horizontal rotation to the distributor plate 304 while vertical movements of the support beam 305 confer no corresponding vertical movement to the distributor plate 304. A non-limiting example of a selective interference arrangement is a pair of mating gear surfaces along opposing surfaces of the support beam 305 and the distributor plate 304, with straight vertical toothed surfaces that enable the transfer of rotational movements between the support beam 305 and the distributor plate 304 while permitting the support beam 305 to translate vertically relative to the distributor plate 304 while maintaining an engagement of the mating toothed surfaces. When the distributor plate 304 is configured to remain at a fixed vertical height, the distributor arm 305 will be made with sufficient length such that vertical movements of the distributor arm 305 will result in vertical displacements of the output end 303b of the distributor arm 303 relative to a through-hole formed through the distributor plate 304, with the output end 303b remaining within the through-hole at all times during such vertical displacements.

When configured to displace vertically together with the distributor arm 303, the distributor plate 304 may simply be fixed to directly to the support beam 305, and the output end 303b of the distributor arm 303 may likewise be permanently fixed to the through-hole of the distributor plate 304. In this configuration, when the distributor arm 303 is moved horizontally to align with a reception portal (not shown) of a buffer chamber 310, the delivery plate 304 is simultaneously moved in a corresponding horizontal movement, and when the distributor arm 303 is moved vertically to engage/disengage a reception portal, the delivery plate 304 is simultaneously moved in a corresponding vertical movement. In such configurations, the delivery plate 304 may be further configured such that, upon a vertical downward movement for engaging the output end 303b of the distributor arm 303 with a reception portal of a given buffer chamber 310, an underside of the delivery plate 304 is simultaneously brought into a position to obstruct the reception portals of all other buffer chambers 310 that are not targeted for engagement by the distributor arm 303. By obstructing the non-targeted reception portals, further protection may be provided against any potential cross-contamination of material feed flows between the separate buffer chambers 310 in the event of a potential spillage or backflow while delivering a material feed flow to a targeted buffer chamber 310.

When the system controller 400 determines that a specific blended batch is needed for delivery to a specific buffer chamber 310, the controller 400 commands the RGBB 200 to generate the necessary blended batch, and further commands the motor 306 of the manifold 300 to rotate the distributor arm 303 such that the output end 303b thereof aligns with a reception portal of the targeted buffer chamber 310 in need of the blended batch. Movement of the distributor arm 303 comprises a first vertical movement to raise the distributor arm 303 for disengagement from a current buffer chamber 310, a horizontal movement to align the distributor arm 303 with a second, targeted buffer chamber 310, and a vertical movement to lower the distributor arm 303 for engagement with the targeted buffer chamber 310. The manifold 300 may comprise a number of sensors 314/315 for ensuring proper alignment of the distributor arm 303 for engaging the reception portals of the buffer chambers 310. FIG. 7 shows a close-up view of a region VII of the manifold 300 as seen in FIG. 6. In this example, the distributor plate 304 is provided with a first distributor sensor 314a and each buffer chamber 310 is provided with a buffer sensor 315, with the system controller 400 in signal communication with at least one of the two sensors to receive signals confirming proper alignment of the distributor arm 303 with a reception portal of a targeted buffer chamber 310 upon successful transmission of a signal between the first distributor sensor 314a and a corresponding buffer sensor 315 for the targeted buffer chamber 310. Optionally, the distributor plate 304 may be provided with a second distributor sensor 314b (FIG. 6) and the system controller 400 may alternatively be operable to confirm proper alignment of the distributor arm 303 with a reception portal of a targeted buffer chamber 310 upon confirming successful transmission of a signal between the second distributor sensor 314b and a buffer sensor 316 (FIG. 7) on a buffer chamber 310 that is adjacent to (or otherwise removed from, e.g., by one, two or more intermediate chambers) the targeted buffer chamber 310. In a further alternative, the distributor plate 304 or a first part of the motor 306 may be provided with a first sensor (not shown) that cooperates with a second sensor (not shown) provided to the support beam 305 or a second part of the motor 306, with these two sensors cooperating (e.g., as a home and encoder sensor, respectively) to determine positioning of the distributor arm 303 relative to the reception portal of each buffer chamber 310 based on a number of pulses between the sensors as defining a rotational position of the distributor plate 304.

Preferably, the manifold 300 is configured to provide a dust-tight seal between the output end 303b of the distributor arm 303 and the reception portals of the buffer chambers 310. A dust-tight seal may be achieved by a number of different sealing mechanisms, or a combination thereof. As one example, the output end 303b of the distributor arm 303 and the reception portals of the buffer chambers 310 may be provided with closely corresponding opening dimensions, and the output end 303b of the distributor arm 303 may be provided with ample length, such that upon inserting the output end 303b into a reception portal the opening of the output end 303b is positioned at a sufficient depth within the buffer chamber 310, and with minimal clearance between an outer diameter of the distributor arm 303 and the reception portal, so as to effectively prevent spillage of a material feed flow. In another example, the output end 303b of the distributor arm 303 and reception portals of the buffer chambers 310 may be provided with mating rubber seals such that vertical engagement of the two is accompanied by a sealing engagement of the corresponding rubber seals. In a further example, the reception portals of the buffer chambers 310 may be provided with self-sealing gaskets that permit insertion and extraction of the output end 303b of the distributor arm 303 while maintaining a dust-tight seal at the reception portal. In yet another example, the output end 303b of the distributor arm 303 and the reception portals of the buffer chambers 310 may be provided with mating magnetic surfaces such that vertical engagement of the two is accompanied by a sealing engagement of the magnetic surfaces. In a yet further example, one or both of the output end 303b of the delivery arm 303 and the reception portals of the buffer chambers 310 may be provided with a spring-mounted bezel adapted to vertically displace upon vertical engagement of the two, for example, by enabling a downward vertical displacement of a bezel at the buffer chamber 310 and/or an upward vertical displacement of a bezel at the distributor arm 303, thereby providing an extended vertical range within 20) which the free ends of the two may be brought into sealing engagement. It will be readily understood that the foregoing examples are non-exhaustive and non-exclusive, and that a dust-tight engagement may also be achieved by combining any number of the foregoing examples. It will be understood that these same sealing mechanisms, and combinations thereof, may also be employed at the underside of the distributor plate 304 for effecting the obstruction of reception portals at non-targeted buffer chambers 310, as described above.

The buffer chambers 310 are provided as-inline chambers for receiving and temporarily storing one or more blended batches in preparation for delivery of the same to one or more designated processing machines (not shown) as a material feed via a delivery pipe 311. The delivery pipe 311 of a buffer chamber 310 may feed directly to a single processing machine, or may be branched to feed multiple processing machines.

The system controller 400 may be in signal communication with one or more sensors for monitoring a fill level of material feed (i.e., a volume of corresponding blended batch) stored within each buffer chamber 310, and if the system controller 400 determines that a level of material feed in any buffer chamber 310 is below a predetermined threshold, the system controller 400 may commend the RGBB 200 and the manifold 300 for generating and delivering a volume of a blended batch of the requisite formulation for any such buffer chamber 310. The system controller 400 may also receive one or more signals from each processing machine, including signals informing that a specific processing machine is in need of additional material feed, and upon receipt of such may command a corresponding buffer chamber 310 to release a corresponding volume of blended batch for delivery to the respective processing machine as a material feed flow via the corresponding delivery pipe 311.

With inclusion of the buffer chambers 310, the manifold 300 is capable of maintaining a pre-loaded quantity of material feed ready for immediate delivery to each processing machine at a moment's notice. This enables each processing machine to immediately receive additional material feed at any moment in time, independent of the then current operation state of the RGBB 200, thereby avoiding potential delays that could otherwise result, for example, if two or more processing machines simultaneously require further material feed. With this configuration, the manifold 300 may be operated to continually ensure that each buffer chamber 310 is provided with a pre-loaded quantity of material feed ready for immediate delivery to each processing machine, and each processing machine may readily receive a batch of material feed at any moment.

The buffer chambers 310 may include access ports 312 that enable access to the contents of the respective chambers or sampling and/or inspection, and airflow filters 313 for the evacuation and/or introduction of an airflow out of and/or into the respective chambers. Airflow filters 313 are provided to maintain adequate pressure levels within the buffer chambers 310, preferably a pressure level corresponding with an atmospheric pressure outside the buffer chambers 310, thereby avoiding over-pressurization upon introduction of a blended batch into the buffer chamber 310 from the distributor arm 303 and avoiding under-pressurization (e.g., a negative, vacuum force) upon release of a blended batch from the respective buffer chamber 310 through the delivery pipe 311. Optionally, airflow filters 313 may be connected to a pressurized fluid source (e.g., a pressurized gas source) which may be operable for evacuating and/or introducing an airflow through the airflow filters 313 to achieve targeted pressure differentials that promote laminar flow of material feeds through the buffer chambers 310.

When preparing blended batches according to different recipes stored in the system controller 400 for use as material feeds for several different processing machines, it is important that each blended batch be prepared with a formulation that carefully conforms to the corresponding formulation of the recipe for the same. However, as the RGBB 200 employs a single weighing hopper 204, a single mixing chamber 206, a single funnel 207, and a single distributor arm 303 for processing all blended batches of varying formulations, there is thus a risk that any residual elements that remain with any of these system components between the processing of a first blended batch according to a first recipe and the processing of a second blended batch according to a second recipe may act as contaminants to the second blended batch, offsetting the formulation of the second blended batch from that required by the second recipe. Systems according to the present are adapted to avoid such potential contaminations by executing a cleansing process.

As shown in FIG. 3, the system controller 400 is in signal communication with a number of flow valves 211/212 for controlling the delivery of a pressurized fluid flow from a pressurized fluid supply 208 to a number of fluid nozzles 209 that are positioned throughout the system. The fluid stored in the pressurized fluid supply 208 and delivered to the fluid nozzles 209 may be pressurized air, or any other suitable fluid (e.g., liquid or gas). Preferably, the system is configured with at least one fluid nozzle 209 for removing residual elements from any system component that regularly handles batches of varying formulations.

In the example shown in FIGS. 3 and 4, the supply hoppers 202a and 202b are each provided with a respective fluid nozzle 209al and 209a2, the weighing hopper 204 is provided with a pair of fluid nozzles 209b1 and 209b2, the mixing chamber 206 is provided with a pair of fluid nozzles 209cl and 209c2, the funnel 207 is provided with a pair of fluid nozzles 209d1 and 209d2, and the distributor arm 303 is provided with a fluid nozzle 209e. The system controller 400 controls the delivery of a pressurized fluid to the fluid nozzles 209a/209b/209c/209d/209e by controlling a first flow valve 211 for releasing a pressurized fluid flow from the pressurized fluid supply 208 and controlling secondary flow valves 212a/212b/212c/212d/212e for directing the pressurized fluid flow to the respective fluid nozzles 209a/209b/209c/209d/209e. In the illustrated example, the funnel 207 is further provided with a venturi pump 213 proximate the outlet thereof for generating a negative pressure force for pulling a material feed toward the outlet of the funnel 207, thereby further promoting complete removal of all pellets of the material feed from the funnel 207.

In operation, when the system controller 400 determines that the system is to change from processing a first blended batch in accord with a first recipe to processing a second blended batch in accord with a second recipe, the system controller 400 first commands the system to cease processing of the first blended batch and then commands the system to execute a cleansing process before providing instructions to begin processing of the second blended batch.

The system controller 400 may instruct execution of a cleansing process to cleanse each of the system components in sequential order, preferably corresponding with an upstream-to-downstream material feed flow sequence of a composite/blended batch. For example, the system controller 400 may provide instructions to first direct a pressurized fluid flow to the fluid nozzles 209a for cleansing the supply hoppers 202, followed by instructions directing a pressurized fluid flow to the fluid nozzles 209b for cleansing the weighing hopper 204, followed by instructions directing a pressurized fluid flow to the fluid nozzles 209c for cleansing the mixing chamber 206, followed by instructions directing a pressurized fluid flow to the fluid nozzles 209d for cleansing the funnel 207, then followed by instructions to direct a pressurized fluid flow to the fluid nozzle 209e for cleansing the distributor arm 303. Alternatively, the system controller 400 may provide instructions directing concurrent pressurized fluid flows to each of the fluid nozzles 209 at the supply hoppers 202, the weighing hopper 204, the mixing chamber 206, the funnel 207, and the distributor arm 303, such that each component is cleansed concurrently with one another. In a concurrent cleansing process, it is preferable that the system controller 400 cease the flows pressurized fluids to each of the fluid nozzles one at a time, in a sequence corresponding with an upstream-to-downstream material feed flow sequence of a composite/blended batch. By controlling the delivery of pressurized fluid flows in an upstream-to-downstream material feed flow sequence, there is a reduced likelihood that a cleansing process executed at an upstream system component (e.g., the weighing hopper) may result in contamination of a downstream system component (e.g., the mixing chamber).

When executing the cleansing process, the system controller 400 may provide instructions to the venturi pump 213 to generate a negative pressure force for pulling pellets of the material feed toward the outlet of the funnel 207, with the negative pressure of the venturi pump 213 being generated concurrently with delivery of the pressurized fluid flow to the fluid nozzles 209d for cleansing the funnel 207. In this way the funnel 207 may be cleansed under the combination of a positive pressure force from the fluid nozzles 209d and a negative pressure force from the venturi pump 213. Though not shown in the drawings, the system may include one or more additional venturi pumps, optionally with a dedicated venturi pump provided at the outlet of each of the supply hoppers 202, the weighing hopper 204, the mixing chamber 206, and/or the distributor arm 303. Any additional venturi pumps added to the system may be operating in similar fashion as the venturi pump 213, with the system controller 400 controlling each venturi pump to generate a negative pressure force concurrently with delivery of a pressurized fluid flow to the fluid nozzles 209 to generate a positive pressure force for that system element.

The system controller 400 may be programmed to employ one of the buffer chambers 310 as a cleansing chamber for reception of residual elements that are removed during a cleansing process. In such examples, when executing a cleansing process, the system controller 400 will first instruct the manifold motor 306 to rotate the distributor arm 303 to engage a targeted buffer chamber 310 that is designated in advance for use as a cleansing chamber. Once the distributor arm 303 is engaged with the cleansing chamber, the cleansing process may be executed with all residual elements that are removed from the upstream system components being delivered to the cleansing chamber, thereby providing a designated receptacle for residual elements that avoids any further contamination of blended batches that will subsequently be delivered to the remaining buffer chambers 310.

Though it is contemplated that a cleansing process will generally be executed when switching the system from processing a first blended batch in accord with a first recipe to processing a second blended batch in accord with a second recipe, the system controller 400 may also be programmed to execute a cleansing process between the processing of blended batches that have a common recipe. This may be done as a periodic cleansing process, for example, after processing a predetermined volume of a blended batch, as a means to avoid an undesirable accumulation and build-up of residual elements within the system.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

For example, though the foregoing disclosures refers to a system controller in the singular tense, it will be understood that the system controller may either be a single control unit having all functionalities described herein or may instead be multiple control units with the several functionalities separated between the individual control units. Likewise, though the foregoing disclosure refers to an example in which several system components are described as having two fluid nozzles positioned proximate an upper region of the system component, it will be understood that each system component may have any number of fluid nozzles provided at various positions and orientations within the component.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

What is claimed is:

1. A system for processing material feeds for use by a plurality of processing machines, the system comprising:
a batch blender comprising a plurality of supply hoppers each for holding a separate batch component, a weighing hopper downstream of the plurality of supply hoppers for receiving batch components from each supply hopper for yielding a composite batch, and a mixing chamber downstream of the weighing hopper for receiving a weighed composite batch from the weighing hopper for yielding a blended batch;
a manifold comprising a distributor and a plurality of buffer chambers, the distributor being configured to receive a blended batch from the mixing chamber of the batch blender and to deliver the received blended batch to a targeted one of the buffer chambers;
a system controller configured for controlling the batch blender and the manifold for preparing and distributing multiple material feeds for use by the plurality of processing machines, each material feed having a different formulation of batch components from one another, wherein the system controller is configured to control the batch blender to prepare each of the multiple material feeds using the same weighing hopper for each of the differently formulated material feeds.

2. The system according to claim 1, further comprising:
a pressurized fluid source containing a pressurized fluid and one or more fluid nozzles provided to one or more system components, the one or more fluid nozzles being in a fluid flow communication with the pressurized fluid source for delivering the pressurized fluid to the one or more system components for cleansing the system of residual material feed elements between separate processing runs of material feeds.

3. The system according to claim 2, wherein
the system controller is configured such that, when controlling the system to switch from a first processing run for preparing a first material feed having a first formulation to a second processing run for preparing a second material feed having a second formulation, the system controller commands the system to execute a cleansing process by delivering the pressurized fluid to the one or more fluid nozzles between the first and second processing runs.

4. The system according to claim 2, wherein
at least one fluid flow nozzle is provided at the weighing hopper.

5. The system according to claim 2, wherein
at least one fluid flow nozzle is provided at the mixing chamber.

6. The system according to claim 2, wherein
at least one fluid flow nozzle is provided at the distributor.

7. The system according to claim 2, wherein
at least one fluid flow nozzle is provided at each of the weighing hopper, the mixing chamber, and the distributor.

8. The system according to claim 1, wherein
the batch blender is a remote gravimetric batch blender.

9. The system according to claim 1, wherein
the batch blender consists of a single weighing hopper.

10. The system according to claim 1, wherein
the distributor comprises a distributor arm that is selectively engageable with reception portals at each of the plurality of buffer chambers for delivering blended batches of material feed from the batch blender to the plurality of buffer chambers.

11. The system according to claim 10, wherein
the distributor arm and reception portals are adapted to engage one another in a dust-tight seal.

12. The system according to claim 10, wherein
the distributor further comprises a distributor plate that is adapted to close-off the reception portals of any buffer chamber in the plurality of buffer chambers that is not targeted for engagement by the distributor arm.

13. The system according to claim 12, wherein
the distributor plate and reception portals are adapted to engage one another in a dust-tight seal.

14. The system according to claim 10, wherein
the system controller is configured to control movements of the distributor arm via a motor that enables both horizontal and vertical displacements of the distributor arm for engaging and disengaging reception portals of the plurality of buffer chambers.

15. The system according to claim 14, wherein
the buffer chambers are arranged in a circular arrangement, and the distributor arm is configured for horizontal displacements via a rotational movement around a vertical axis at a center of the circular arrangement.

16. The system according to claim 1, wherein
a system controller is configured to monitor a fill level of the plurality of buffer chambers, and to control the batch blender and distributor for providing further material feed to any buffer chamber that is determined to contain a material feed volume below a predetermined threshold.
